(19) United States
(12) Patent Application Publication
(10) Pub. No.: US 2019/0039878 A1
(43) Pub. Date: Feb. 7, 2019

(54) MATERIAL SUPPLY DEVICE

(71) Applicants: BOE TECHNOLOGY GROUP CO., LTD., Beijing (CN); HEFEI XINSHENG OPTOELECTRONICS TECHNOLOGY CO., LTD., Anhui (CN)

(72) Inventors: Pengyu LI, Beijing (CN); Shuai LUO, Beijing (CN); Wei CHENG, Beijing (CN); Gang WANG, Beijing (CN); Dezhi WANG, Beijing (CN)

(73) Assignees: BOE TECHNOLOGY GROUP CO., LTD., Beijing (CN); HEFEI XINSHENG OPTOELECTRONICS TECHNOLOGY CO., LTD ., Anhui (CN)

(21) Appl. No.: 15/971,371

(22) Filed: May 4, 2018

(30) Foreign Application Priority Data
Aug. 4, 2017 (CN) 201710661874.5

(51) Int. Cl. B67D 7/02; B67D 7/30; B67D 7/72

(52) U.S. Cl. CPC B67D 7/0277; B67D 7/763; B67D 7/725; B67D 7/30

(57) ABSTRACT

A material supply device is provided, to eliminate bubbles in materials supplied by the material storage tank to the glue supply syringe. The material supply device includes: a material storage tank; a material supply tank provided with a material supply outlet; and a bubble elimination component, configured to be in communication with the material storage tank and the material supply tank and eliminate bubbles in materials supplied by the material storage tank to the material supply tank.

### CROSS-REFERENCE TO RELATED APPLICATION

This application claims priority to Chinese Patent Application No. 201710661874.5 filed Aug. 4, 2017, which is incorporated herein by reference in its entirety.

### TECHNICAL FIELD

The present disclosure relates to the field of display manufacture, and in particular to a material supply device.

### BACKGROUND

In the related art, a glue supply device is required in a bonding process. The glue supply device used in a full bonding process has a simple structure and a low cost, however a glue supply syringe thereof has the following disadvantages: 1) the glue supply tank is controlled by pressure, so a glue exhausting ability may be poor and a glue exhausting amount may not be adjusted precisely; 2) the glue supply syringe may be discarded frequently, so the device may not be produced continuously; 3) bubbles in the pipelines of the glue supply device may not be exhausted, so the glue exhausting may be abnormal; 4) the glue storage tank is far away from the glue supply syringe, the pressure may be changed during the glue supply, so the glue exhausting pressure may be nonuniform; 5) the glue supply rate and amount may not be adjusted frequently.

### SUMMARY

A material supply device is provided in the present disclosure, to eliminate bubbles in materials supplied by the material storage tank to the glue supply syringe. The material supply device includes: a material storage tank; a material supply tank provided with a material supply outlet; and a bubble elimination component, configured to be in communication with the material storage tank and the material supply tank and eliminate bubbles in materials supplied by the material storage tank to the material supply tank.

Optionally, the bubble elimination component includes a relay tank configured to be in communication with the material storage tank and the material supply tank, where a first material inlet configured to be in communication with the material storage tank is arranged at a top of the relay tank, and a first material outlet configured to be in communication with the material supply tank is arranged at a bottom of the relay tank.

Optionally, the relay tank is provided with a negative pressure interface configured to form a negative pressure environment in the relay tank to draw the materials to the relay tank from the material storage tank.

Optionally, the relay tank is further provided with a positive pressure interface configured to form a positive pressure environment in the relay tank to press the materials from the relay tank to the material supply tank.

Optionally, the relay tank is further provided with a liquid level sensor, and the material supply device further includes a first controller connected to the liquid level sensor, the positive pressure interface and the negative pressure interface and configured to open the negative pressure interface and close the positive pressure interface in the case that a current liquid level detected by the liquid level sensor does not reach a predetermined liquid level.

Optionally, the liquid level sensor is an ultrasonic sensor.

Optionally, the material supply tank is a piston material supply pump including a tank body and a piston, where a bottom of the tank body is opened, and the piston is arranged at the bottom of the tank body and capable of moving in the tank body in a reciprocating manner, a second material inlet, the material supply outlet and an air exhaust port are arranged at a top of the tank body.

Optionally, the material supply device further includes a second controller connected to a drive mechanism of the piston, the second material inlet, the material supply outlet and the air exhaust port and configured to control the piston to move in the tank body in a reciprocating manner and open or close the second material inlet, the material supply outlet and the air exhaust port based on a predetermined material supply parameter.

Optionally, the second controller is configured to control the piston to move away from the top of the tank body, to form a negative pressure environment in the tank body to draw the materials from the bubble elimination component, in the case that the second material inlet is opened and the material supply outlet and the air exhaust port are closed under a control of the second controller; the second controller is further configured to control the piston to move close to the top of the tank body to exhaust the air from the tank body, in the case that the second material inlet and the material supply outlet are closed and the air exhaust port is opened under the control of the second controller; the second controller is further configured to control the piston to move close to the top of the tank body to exhaust the materials from the tank body through the material supply outlet, in the case that the second material inlet and the air exhaust port are closed and the material supply outlet is opened under the control of the second controller.

Optionally, the second controller is further configured to, prior to opening the second material inlet, control a movement state of the piston to adjust a predetermined air pressure within the tank body; the second controller is further configured to, prior to closing the material supply outlet, control the piston to move away from the top of the tank body, to draw back the materials remaining around the material supply outlet.

Optionally, the first material inlet of the relay tank is configured to be in communication with the second material inlet of the material supply tank.

Optionally, the relay tank is further provided with a liquid level sensor, and the material supply device further includes a first controller connected to the liquid level sensor, the positive pressure interface and the negative pressure interface and configured to close the negative pressure interface and open the positive pressure interface in the case that a current liquid level detected by the liquid level sensor reaches a predetermined liquid level.

### BRIEF DESCRIPTION OF THE DRAWINGS

FIG. 1 is a schematic view of a first glue supply device in the related art;

FIG. 2 is a schematic view of a second glue supply device in the related art;

FIG. 3 is a schematic view of a material supply device in some embodiments of the present disclosure;

FIG. 4 shows a connection among a first controller, a liquid level sensor, a positive pressure interface and a negative pressure interface in some embodiments of the present disclosure; and

FIG. 5 shows a connection among a second controller, a drive mechanism of a piston, a second material inlet, a material supply outlet and an air exhaust in some embodiments of the present disclosure.

### DETAILED DESCRIPTION

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

There are two kinds of glue supply devices used in the full bonding process in the related art.

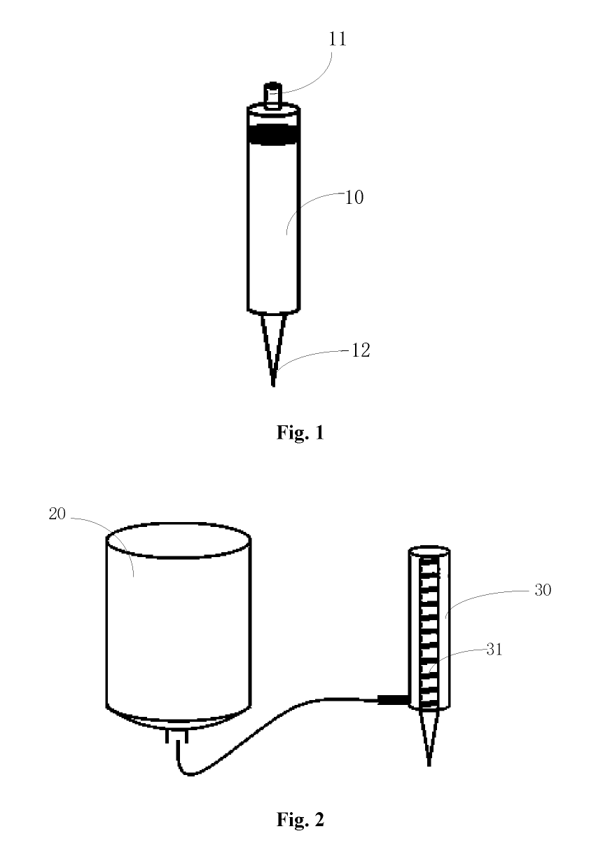

In the first kind of glue supply device, as shown in FIG. 1, the glue supply device applies a glue supply syringe 10, a top thereof is closed and provided with a pressure source interface 11, and the glue in the syringe outflows from a glue exhausting port after being pressed. The above kind of glue supply device has a simple structure and a low cost, however a glue supply syringe thereof has the following disadvantages: 1) the glue supply tank is controlled by pressure, so a glue exhausting ability may be poor and a glue exhausting amount may not be adjusted precisely; 2) the glue supply syringe may be discarded frequently, so the device may not be produced continuously.

In the first kind of glue supply device, as shown in FIG. 2, the glue supply device mainly includes a glue storage tank 20 and a glue tank 30, and a glue outlet of the glue storage tank 20 is connected to a glue inlet of the glue tank 30. The above kind of glue supply device has the following disadvantages: 1) bubbles in the pipelines of the glue supply device may not be exhausted, so the glue exhausting may be abnormal; 2) the glue storage tank is far away from the glue supply syringe, the pressure may be changed during the glue supply, so the glue exhausting pressure may be nonuniform; 3) the glue supply rate and amount may not be adjusted frequently.

In view of the above technical issues in the related art, a material supply device is provided in the present disclosure, to eliminate bubbles in the materials thereby to solve the above technical issues.

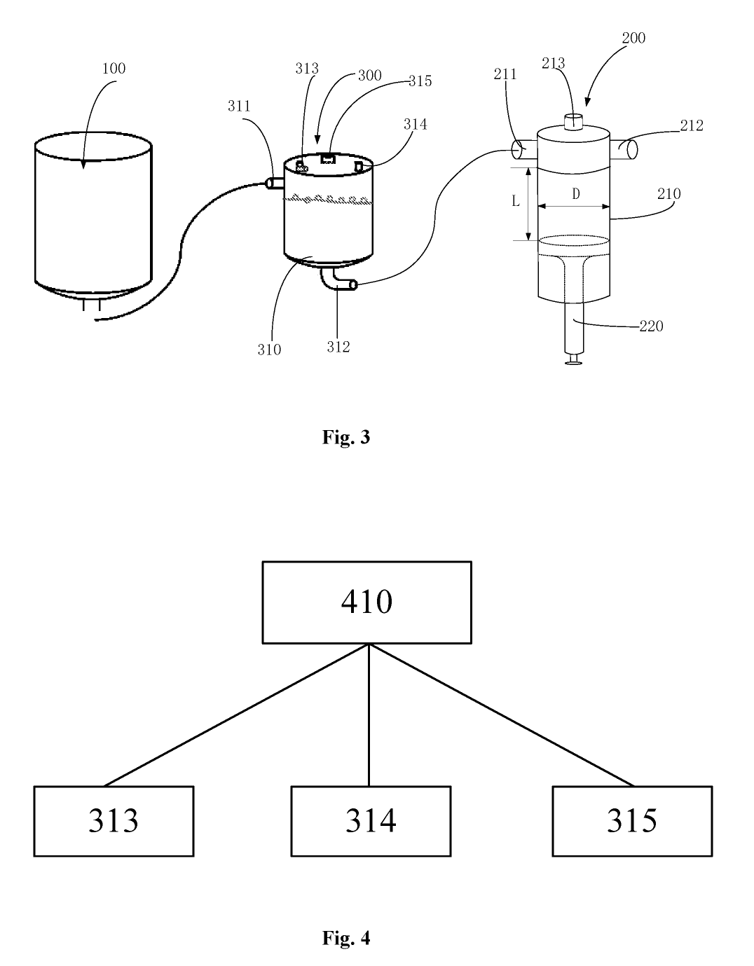

As shown in FIG. 3, a material supply device provided in some embodiments of the present disclosure includes: a material storage tank 100; a material supply tank 200 provided with a material supply outlet 212; and a bubble elimination component 300, configured to be in communication with the material storage tank 100 and the material supply tank 200 and eliminate bubbles in materials supplied by the material storage tank 100 to the material supply tank 200.

According to the material supply device in some embodiments of the present disclosure, the bubble elimination component 300 configured to be in communication with the material storage tank 100 and the material supply tank 200 may eliminate and exhaust bubbles, thereby eliminating the bubbles in the materials (e.g., a glue) supplied by the material storage tank 100 to the material supply tank 200 and solving the abnormal material supply due to the bubbles.

It should be noted that, the material supply device in some embodiments of the present disclosure may be applied to supply glue during the full bonding process or supply other materials. The material supply device may be described hereinafter by taking an example that the material supply device is applied to supply the glue.

In some embodiments of the present disclosure, as shown in FIG. 3, the bubble elimination component 300 includes a relay tank 310 configured to be in communication with the material storage tank 100 and the material supply tank 200. A first material inlet 311 configured to be in communication with the material storage tank 100 is arranged at a top of the relay tank 310, and a first material outlet 312 configured to be in communication with the material supply tank 200 is arranged at a bottom of the relay tank 310.

According to the above embodiments, the bubble elimination component 300 is the relay tank 310 between the material storage tank 100 and the material supply tank 200. The top of the relay tank 310 is in communication with the material storage tank 100, so as to introduce the glue. The bottom of the relay tank 310 is in communication with the material supply tank 200, so as to supply the glue to the material supply tank 200. When the glue in the material storage tank 100 enters into the relay tank 310, bubbles in the glue may float on a surface of the glue, thereby eliminating and exhausting the bubbles.

It should be appreciated that, according to the above bubble elimination component 300, it is merely needed to arrange the relay tank 310 between the material storage tank 100 and the material supply tank 200, so the structure is simple and it is easy to be implemented. In addition, in compared with the related art where the glue is directly supplied to the material supply tank 200 from the material storage tank 100, the relay tank 310 may balance the glue supply pressure, so it is able to steady the pressure when applying the glue to the material supply tank 200 from the material storage tank 100, quantify the glue supply amount, improve an initial glue supply pressure, steady the glue supply amount.

It should be noted that, in some embodiments of the present disclosure, the relay tank 310 may be implemented in other manner, which is not limited in the present disclosure.

In some embodiments of the present disclosure, as shown in FIG. 3, the relay tank 310 is provided with a negative pressure interface 313 configured to form a negative pressure environment in the relay tank 310, so as to draw the materials to the relay tank 310 from the material storage tank 100.

According to the above embodiments, the relay tank 310 is provided with the negative pressure interface 313, when the glue is supplied to the relay tank 310 from the material storage tank 100, the negative pressure interface 313 is opened and the glue is drawn to the relay tank 310 gradually. In addition, because of the negative pressure environment in the relay tank 310, the bubbles in the glue may be float on the surface of the glue.

In some embodiments of the present disclosure, as shown in FIG. 3, the relay tank 310 is provided with a positive pressure interface 314 configured to form a positive pressure environment in the relay tank 310, so as to press the materials from the relay tank 310 to the material supply tank 200.

According to the above embodiments, the relay tank 310 is provided with the positive pressure interface 314, when the glue in the relay tank 310 reaches a predetermined liquid level, the negative pressure interface 313 is closed and the positive pressure interface 314 is opened, so as to press the glue in the relay tank 310 to the material supply tank 200. The glue supply pressure is adjusted by controlling the positive pressure, so the glue supply pressure is stable.

In addition, in some embodiments of the present disclosure, as shown in FIG. 3, the relay tank 310 is further provided with a liquid level sensor 315, and the material supply device further includes a first controller 410 connected to the liquid level sensor 315, the positive pressure interface 314 and the negative pressure interface 313 and configured to open the negative pressure interface 313 and close the positive pressure interface 314 in the case that a current liquid level detected by the liquid level sensor 315 does not reach a predetermined liquid level, or close the negative pressure interface 313 and open the positive pressure interface 314 in the case that the current liquid level detected by the liquid level sensor 315 reaches the predetermined liquid level.

According to the above embodiments, the relay tank 310 may draw and supply the glue automatically by the cooperation of the liquid level sensor 315 and the first controller 410. To be specific, the glue drawing and supplying processes are described as follows.

When the material storage tank 100 supplies the glue to the relay tank 310, the first controller 410 opens the first material inlet 311 and the negative pressure interface 313 and closes the first material outlet 312 and the positive pressure interface 314, and the glue is drawn to the relay tank 310 gradually. The bubbles in the glue may float on the surface of the glue due to the negative pressure in the relay tank 310. When the glue reaches the predetermined liquid level, the liquid level sensor 315 sends a signal to the first controller 410, the first controller 410 closes the first material inlet 311 and the negative pressure interface 313, and then the glue supplying is finished. The first controller 410 opens the first material outlet 312 and the positive pressure interface 314, and then the relay tank 310 starts to supply the glue to the material supply tank 200.

In some embodiments of the present disclosure, a connection among the first controller 410, the liquid level sensor 315, the positive pressure interface 314 and the negative pressure interface 313 is shown in FIG. 4.

In some embodiments of the present disclosure, the liquid level sensor 315 is an ultrasonic sensor.

In addition, in some embodiments of the present disclosure, as shown in FIG. 3, the material supply tank 200 is a piston material supply pump including a tank body 210 and a piston 220. A bottom of the tank body 210 is opened, and the piston 220 is arranged at the bottom of the tank body 210 and capable of moving in the tank body 210 in a reciprocating manner. A second material inlet 211, the material supply outlet 212 and an air exhaust port 213 are arranged at a top of the tank body 210.

According to the above embodiments, the piston material supply pump serves as the material supply tank 200, so the glue supply state of the material supply tank 200 may be controlled by controlling the movement of the piston 220. In compared with the related art, the piston material supply pump may control the movement of the piston 220 through a servo motor, so it is able to quantify the glue supply amount and rate, and an accuracy degree may be 0.1 cc.

In some embodiments of the present disclosure, the material supply device further includes a second controller 420 connected to a drive mechanism 221 of the piston 220, the second material inlet 211, the material supply outlet 212 and the air exhaust port 213 and configured to control the movement of the piston 220 in the tank body and open or close the second material inlet 211, the material supply outlet 212 and the air exhaust port 213 based on a predetermined material supply parameter.

According to the above embodiments, it is able to control the movement of the piston 220 based on the predetermined material supply parameter, so as to adjust the glue supply amount and rate.

In some embodiments of the present disclosure, the second controller 420 is configured to control the piston 220 to move outward the tank body 210 to form a negative pressure environment in the tank body 210, so as to draw the materials from the bubble elimination component 300, in the case that the second material inlet 211 is opened and the material supply outlet 212 and the air exhaust port 213 are closed under a control of the second controller 420.

The second controller 420 is further configured to control the piston 220 to move into the tank body 210 to exhaust the air from the tank body 210, in the case that the second material inlet 211 and the material supply outlet 212 are closed and the air exhaust port 213 is opened under the control of the second controller.

The second controller 420 is further configured to control the piston 220 to move into the tank body 210 to exhaust the materials from the tank body 210 through the material supply outlet 212, in the case that the second material inlet 211 and the air exhaust port 213 are closed and the material supply outlet 212 is opened under the control of the second controller.

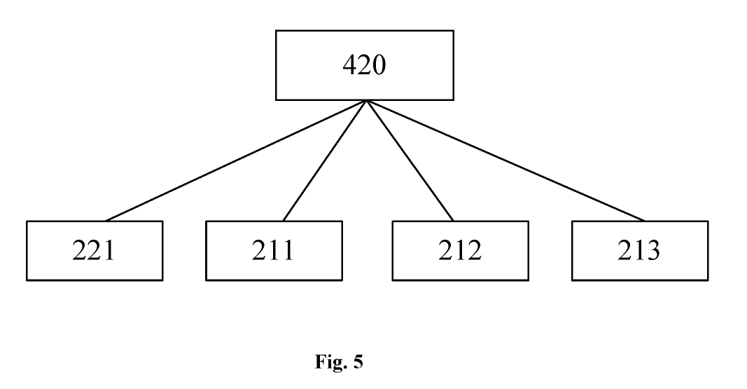

In some embodiments of the present disclosure, a connection among the second controller 420, the drive mechanism 211 of the piston 220, the second material inlet 211, the material supply outlet 212 and the air exhaust 213 is shown in FIG. 5.

The glue drawing and exhausting processes of the material supply tank 200 of the material supply device in some embodiments of the present disclosure are described as follows.

When the glue in the relay tank 310 reaches a predetermined liquid level, the second controller 420 controls the drive mechanism 221 of the piston 220 to move the piston 220 outward the tank body 210. Then the glue is moved from the first material outlet 312 of the relay tank 310 to the second material inlet 211 of the material supply tank 200 due to the negative pressure in the tank body 210 caused by the movement of the piston 220 (the material storage tank does not supply the glue directly, so the glue drawing pressure of the glue supply tank 200 is stable), and then the glue drawing of the glue supply tank 200 is finished.

After the glue drawing of the glue supply tank 200 is finished, the second material inlet 211 of the material supply tank 200 and the material supply outlet are closed, and the air exhaust 213 is opened, the piston 220 of the material supply tank 200 moves inward the tank body 210, so as to exhaust the bubbles in the pipelines from the air exhaust 213, and the bubble elimination of the material supply tank 200 is finished.

After the bubble elimination of the material supply tank 200 is finished, the piston 220 continues to move inward the tank body 210 to press the glue, the second material inlet 211 and the air exhaust 213 are closed, the material supply outlet 212 is opened, and then the glue is exhausted through the material supply outlet 212 to a coating mechanism.

The glue supply amount of the material supply tank 200 is C=π×(½×D)̂2×L, where L represents a piston stroke of the piston 220, D represents an inner diameter of the piston 220. L=v×t, where v represents a moving speed of the piston 220, t represents a moving duration of the piston 220, and v and t may be determined based on the required glue supply amount.

In addition, in the related art, the glue supply pressure of the glue supply device is low at the beginning of the glue supply, and the glue supply amount is large at the end of the glue supply. In order to solve the above technical issue in the related art, the second controller 420 in some embodiments of the present disclosure is further configured to, prior to opening the second material inlet 211, control a movement state of the piston 220 to adjust a predetermined air pressure within the tank body 210, and the second controller 420 is further configured to, prior to closing the material supply outlet 212, control the piston 220 to move outward the tank body 210, to draw back the materials remaining around the material supply outlet 212.

According to the above embodiments, by finely adjusting a duration of the predetermined pressure and the time of the drawing back, it is able to solve the above technical issues in the related art, thereby steadying the glue supply amount and uniforming the glue supply amounts at the beginning and the end of the glue supply operation. The pressure within the material supply tank 200 and the pipelines may be adjusted by controlling the movement of the piston 220. That is, by the predetermined pressure lasted for a duration t₁, it is able to solve the technical issues of a relative large or small pressure with the material supply tank 200 after the material supply tank 200 draws the glue for the first time. In addition, after the glue supply of the material supply tank 200 is finished, the piston 220 may move outward the tank body 210 slightly to draw back the materials for a duration t₂, so as to prevent the glue from flowing at the end of the glue supply due to a pressure inertia, thereby steadying and uniforming the glue supply amount.

The above descriptions of the embodiments are merely intended to facilitate understanding of the methods and the core thought thereof. It should be noted that, a person skilled in the art may make improvements and modifications without departing from the principle of the present disclosure, and these improvements and modifications shall also fall within the scope of the present disclosure.

What is claimed is:

1. A material supply device, comprising:
a material storage tank;
a material supply tank provided with a material supply outlet; and
a bubble elimination component, configured to be in communication with the material storage tank and the material supply tank and eliminate bubbles in materials supplied by the material storage tank to the material supply tank.

2. The device according to claim 1, wherein the bubble elimination component comprises a relay tank configured to be in communication with the material storage tank and the material supply tank, wherein a first material inlet configured to be in communication with the material storage tank is arranged at a top of the relay tank, and a first material outlet configured to be in communication with the material supply tank is arranged at a bottom of the relay tank.

3. The device according to claim 2, wherein the relay tank is provided with a negative pressure interface configured to form a negative pressure environment in the relay tank to draw the materials to the relay tank from the material storage tank.

4. The device according to claim 3, wherein the relay tank is further provided with a positive pressure interface configured to form a positive pressure environment in the relay tank to press the materials from the relay tank to the material supply tank.

5. The device according to claim 4, wherein the relay tank is further provided with a liquid level sensor, and the material supply device further comprises a first controller connected to the liquid level sensor, the positive pressure interface and the negative pressure interface and configured to open the negative pressure interface and close the positive pressure interface in the case that a current liquid level detected by the liquid level sensor does not reach a predetermined liquid level.

6. The device according to claim 5, wherein the liquid level sensor is an ultrasonic sensor.

7. The device according to claim 1, wherein the material supply tank is a piston material supply pump comprising a tank body and a piston, wherein a bottom of the tank body is opened, and the piston is arranged at the bottom of the tank body and capable of moving in the tank body in a reciprocating manner, a second material inlet, the material supply outlet and an air exhaust port are arranged at a top of the tank body.

8. The device according to claim 7, further comprising a second controller connected to a drive mechanism of the piston, the second material inlet, the material supply outlet and the air exhaust port and configured to control the piston to move in the tank body in a reciprocating manner and open or close the second material inlet, the material supply outlet and the air exhaust port based on a predetermined material supply parameter.

9. The device according to claim 8, wherein the second controller is configured to control the piston to move away from the top of the tank body, to form a negative pressure environment in the tank body to draw the materials from the bubble elimination component, in the case that the second material inlet is opened and the material supply outlet and the air exhaust port are closed under a control of the second controller;
the second controller is further configured to control the piston to move close to the top of the tank body to exhaust the air from the tank body, in the case that the second material inlet and the material supply outlet are closed and the air exhaust port is opened under the control of the second controller;
the second controller is further configured to control the piston to move close to the top of the tank body to exhaust the materials from the tank body through the material supply outlet, in the case that the second material inlet and the air exhaust port are closed and the material supply outlet is opened under the control of the second controller.

10. The device according to claim 8, wherein the second controller is further configured to, prior to opening the second material inlet, control a movement state of the piston to adjust a predetermined air pressure within the tank body;
the second controller is further configured to, prior to closing the material supply outlet, control the piston to move away from the top of the tank body, to draw back the materials remaining around the material supply outlet.

11. The device according to claim 2, wherein the material supply tank is a piston material supply pump comprising a tank body and a piston, wherein a bottom of the tank body is opened, and the piston is arranged at the bottom of the tank body and capable of moving in the tank body in a reciprocating manner, a second material inlet, the material supply outlet and an air exhaust port are arranged at a top of the tank body.

12. The device according to claim 11, wherein the first material inlet of the relay tank is configured to be in communication with the second material inlet of the material supply tank.

13. The device according to claim 4, wherein the relay tank is further provided with a liquid level sensor, and the material supply device further comprises a first controller connected to the liquid level sensor, the positive pressure interface and the negative pressure interface and configured to close the negative pressure interface and open the positive pressure interface in the case that a current liquid level detected by the liquid level sensor reaches a predetermined liquid level.
